(19) United States
(12) Patent Application Publication
(10) Pub. No.: US 2014/0055882 A1
(43) Pub. Date: Feb. 27, 2014

(54) REAL TIME CLOSE LOOP FLY HEIGHT CONTROL

(71) Applicants: Ming Jin, Fremont, CA (US); Fan Zhang, Milpitas, CA (US); Haitao Xia, San Jose, CA (US); Wu Chang, Sunnyvale, CA (US)

(72) Inventors: Ming Jin, Fremont, CA (US); Fan Zhang, Milpitas, CA (US); Haitao Xia, San Jose, CA (US); Wu Chang, Sunnyvale, CA (US)

(73) Assignee: LSI Corporation, Milpitas, CA (US)

(21) Appl. No.: 13/593,682

(22) Filed: Aug. 24, 2012

(51) Int. Cl. G11B 21/02

(52) U.S. Cl. 360/75; G9B/21.003

(57) ABSTRACT

A device includes a disk drive assembly configured to store information using a platter comprising a magnetic material surface and a magnetic head disposed above the magnetic material surface. The magnetic head is configured to move across tracks formed on the platter to write information to the magnetic material surface and read information from the magnetic material surface. The device also includes a controller operatively coupled with the disk drive assembly. The controller is configured to dynamically adjust the height of the magnetic head above the magnetic material surface at each of the tracks by determining a harmonic ratio for a particular track and comparing the harmonic ratio to a reference harmonic ratio for the track. For example, the controller calculates a difference between the harmonic ratio and the reference harmonic ratio.

### BACKGROUND

A hard disk drive (HDD), which can also be referred to as a hard drive, a hard disk, or a disk drive, is a device for storing and retrieving digital information, such as computer data. Generally a HDD includes one or more rigid, rapidly rotating discs (platters) coated with magnetic material. A magnetic head can be used to write data to the surface of a platter, and to read data from the surface of the platter.

### SUMMARY

Techniques are described for dynamically adjusting the flying height of a magnetic head positioned above a magnetic material surface of a disk drive assembly. A device includes a disk drive assembly configured to store information using a platter comprising a magnetic material surface and a magnetic head disposed above the magnetic material surface. The magnetic head is configured to move across tracks formed on the platter to write information to the magnetic material surface and read information from the magnetic material surface. The device also includes a controller operatively coupled with the disk drive assembly. The controller is configured to dynamically adjust the height of the magnetic head above the magnetic material surface at each of the tracks by determining a harmonic ratio for a particular track and comparing the harmonic ratio to a reference harmonic ratio for the track. For example, the controller calculates a difference between the harmonic ratio and the reference harmonic ratio.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1 is a diagrammatic illustration of a disk drive assembly and a controller for dynamically adjusting the flying height of a magnetic head positioned above a magnetic material surface of the disk drive assembly in accordance with example implementations of the present disclosure.

FIG. 2 is a flow diagram illustrating a method for dynamically adjusting the flying height of a magnetic head positioned above a magnetic material surface of a disk drive assembly in accordance with example implementations of the present disclosure.

### DETAILED DESCRIPTION

A stable low flying height is often desirable for hard disk drive (HDD) storage devices, e.g., to achieve a lower bit error rate (BER) than would be achievable with, for instance, a higher flying height. Thus, thermal flying height control techniques are typically used with HDDs. Generally, these techniques use thermal deformation of a magnetic head furnished using heat applied to the magnetic head. The amount of heat can be controlled using current supplied through a resistance heater, which can be positioned proximate to a read/write head. A default amount of current (current value) can be applied with the objective of achieving a particular flying height. However, due to operating conditions (e.g., environmental changes and so forth), the actual flying height can be different than an expected flying height, even when the amount of current supplied to a resistance heater is held substantially constant. In some instances, variation in flying height can result in head crash and/or HDD failure.

Techniques are described for implementing dynamic (e.g., real time or at least substantially real time) close loop fly height control in a HDD system. Techniques of the present disclosure can provide a constant, or at least substantially constant, flying height and can be used with various HDD signal processing techniques, including algorithms, digital signal processing (DSP), coding, read channel techniques, and so forth. A dynamic fly height (DFH) reference harmonic ratio can be determined for a selected servo burst (e.g., over a servo burst field). The DFH reference harmonic ratio can be determined during, for instance, a factory manufacturing process. A DFH reference harmonic ratio can be determined for each servo wedge for each track on a HDD during a servo repeatable runout (RRO) test, and can be saved in a RRO field. This can result in a minimal increase in test time for the HDD during manufacturing. Additionally, DFH reference harmonic ratios can be determined after manufacturing of a HDD has been completed.

During operation of a HDD in the field, a channel can dynamically (e.g., continuously, periodically, randomly, pseudorandomly, and so forth) determine a harmonic ratio for a particular track and compare this harmonic ratio with the reference value for the track. For example, a channel can determine a harmonic ratio for a current track and compare this harmonic ratio with a reference value for the current track stored in a RRO field. In some instances, the difference between a dynamically determined harmonic ratio and a reference harmonic ratio can be calculated, and the difference can be compared to a threshold value. In some implementations, when the difference is larger than the threshold value, the flying height can be adjusted to reduce and/or minimize the harmonic ratio difference. Further, a touch down test can be initiated to recalibrate harmonic ratio reference values.

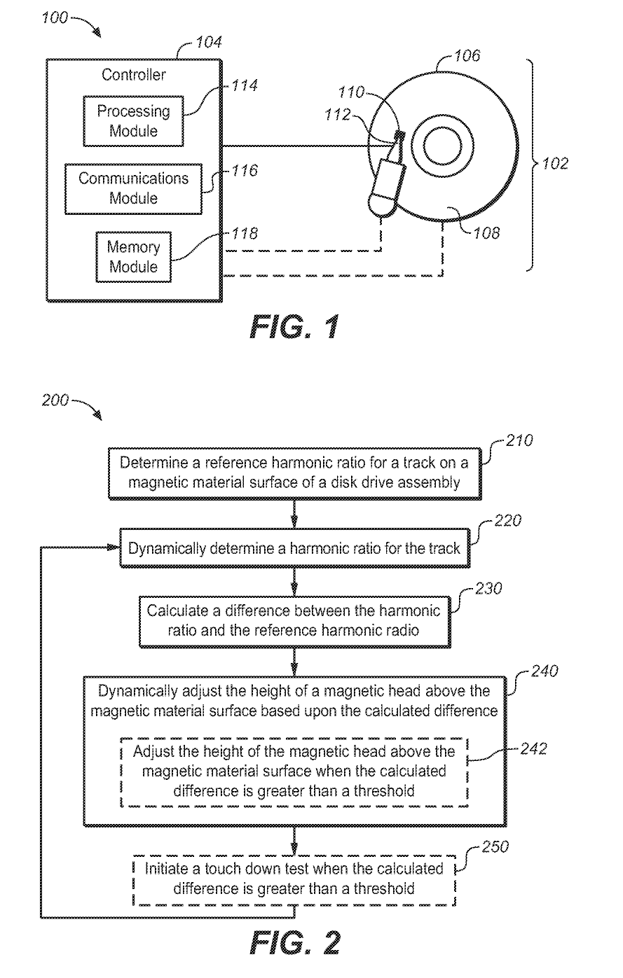

Referring now to FIG. 1, a device 100 includes a disk drive assembly 102 and a control module, such as a controller 104. The disk drive assembly 102 is configured to store information using, for example, a platter (e.g., a disc platter 106) having a magnetic material surface 108 and a read/write head assembly including a magnetic head 110, which is positioned above the magnetic material surface 108. The magnetic head 110 is configured to move across a number of tracks that are formed on the platter 106 to write information to the magnetic material surface 108 and read information from the magnetic material surface 108. The data on the disk platter 106 includes groups of magnetic signals that may be detected by the read/write head assembly when the assembly is properly positioned over the disk platter 106. In one or more implementations, the disk platter 106 includes magnetic signals recorded on data tracks in accordance with either a longitudinal or a perpendicular recording scheme. Once the read/write head assembly is positioned adjacent the proper data track, magnetic signals representing data on the disk platter 106 are sensed by the read/write head assembly as the disk platter 106 is rotated by a spindle motor, or the like. The sensed magnetic signals can be provided as a continuous, minute analog signal representative of the magnetic data on the disk platter 106. A write operation is substantially the opposite of the preceding read operation, where data is encoded and written to one or more data tracks on the disk platter 106.

The controller 104 is operatively coupled with the disk drive assembly 102 (e.g., to control one or more operations of the disk drive assembly 102). For example, the controller 104 can be coupled with the read/write head assembly and used to dynamically adjust the height of the magnetic head 110 above the magnetic material surface 108 at each track. In implementations, the controller 104 can also be operatively coupled with other components of the disk drive assembly 102 (e.g., to control operation of a spindle motor for rotating the disk platter 106, and so forth). In implementations, the disk drive assembly 102 includes a resistance heater 112 positioned proximate to the magnetic head 110. The resistance heater 112 can be used to adjust the height of the magnetic head 110 above the magnetic material surface 108 using, for instance, a digital-to-analog converter (DAC) connected to the resistance heater 112. The controller 104 may be operatively coupled with the DAC, e.g., to control current supplied to the DAC to adjust the operation of the resistance heater 112 and the height of the magnetic head 110 above the magnetic material surface 108.

The controller 104 can adjust the height of the magnetic head 110 by using a harmonic ratio determined dynamically (e.g., in real time, or at least substantially in real time) for a particular track. In implementations, the dynamically determined harmonic ratio can be compared to a reference harmonic ratio for the track. For example, a difference between the dynamically determined harmonic ratio and the reference harmonic ratio can be calculated. In some instances, reference harmonic ratios are determined for one or more tracks of the disk drive assembly 102 during a manufacturing process. For example, a default DFH DAC value can be applied for a particular track, and the resulting harmonic ratio can be determined over a servo field (e.g., a servo burst field) for the track. This harmonic ratio can be saved as a reference value in a RRO field associated with a servo wedge.

In some instances when the difference between a dynamically determined harmonic ratio and a reference harmonic ratio is larger than a threshold value, the controller 104 can be used to adjust the DFH power DACs to reduce and/or minimize the harmonic ratio difference. Additionally, when the difference between a dynamically determined harmonic ratio and a reference harmonic ratio is larger than a threshold value a touch down test can be initiated to recalibrate default DFH DACs. For example, another harmonic ratio can be determined (e.g., when the device 100 is deployed in the field) as the result of a touch down test, and the newly determined harmonic ratio can be saved as a reference value in a RRO field associated with a servo wedge. It should be noted that use of a harmonic ratio to dynamically adjust the flying height of the magnetic head 110 is provided by way of example only and is not meant to be restrictive of the present disclosure. Thus, in other implementations, one or more different parameters can be dynamically measured to facilitate adjustment of the flying height of the magnetic head 110.

As illustrated in FIG. 1, the disk drive assembly 102 may be coupled with the controller 104 for controlling the disk drive assembly 102. The controller 104 may include a processing module 114, a communications module 116, and a memory module 118. The processing module 114 provides processing functionality for the controller 104 and may include any number of processors, micro-controllers, or other processing systems and resident or external memory for storing data and other information accessed or generated by the controller 104. The processing module 114 may execute one or more software programs which implement techniques described herein. The processing module 114 is not limited by the materials from which it is formed or the processing mechanisms employed therein and, as such, may be implemented via semiconductor(s) and/or transistors (e.g., using electronic integrated circuit (IC) components), and so forth. The communications module 116 is operatively configured to communicate with components of the disk drive assembly 102. For example, the communications module 116 can be configured to transmit data for storage in the disk drive assembly 102, retrieve data from storage in the disk drive assembly 102, and so forth. The communications module 116 is also communicatively coupled with the processing module 114 (e.g., to facilitate data transfer between the disk drive assembly 102 and the processing module 114).

The memory module 118 is an example of tangible computer-readable media that provides storage functionality to store various data associated with operation of the controller 104, such as software programs and/or code segments, or other data to instruct the processing module 114, and possibly other components of the controller 104, to perform the steps described herein. For example, memory module 118 may be used to store control programming for dynamically adjusting the flying height of the magnetic head 110 with respect to the magnetic material surface 108. Although a single memory module 118 is shown, a wide variety of types and combinations of memory may be employed. The memory module 118 may be integral with the processing module 114, may comprise stand-alone memory, or may be a combination of both. The memory module 118 may include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, USB memory devices, and so forth. In embodiments, the controller 104 and/or memory module 118 may include removable integrated circuit card (ICC) memory, such as memory provided by a subscriber identity module (SIM) card, a universal subscriber identity module (USIM) card, a universal integrated circuit card (UICC), and so on.

Referring now to FIG. 2, example techniques are described for implementing dynamic (e.g., real time or at least substantially real time) close loop fly height control in a HDD system. FIG. 2 depicts a process 200, in an example implementation, for adjusting the flying height of a magnetic head, such as the magnetic head 110 illustrated in FIG. 1 and described above.

In the process 200 illustrated, a reference harmonic ratio is determined for a track on a magnetic material surface of a disk drive assembly (Block 210). For example, with reference to FIG. 1, a reference harmonic ratio can be determined for a particular track of the magnetic material surface 108 during a manufacturing process. Then, a harmonic ratio can be dynamically determined for the track (Block 220). For instance, with continuing reference to FIG. 1, a harmonic ratio can be determined for a particular track of the magnetic material surface 108 in the field. Next, a difference can be calculated between the harmonic ratio and the reference harmonic ratio (Block 230). Then, the height of a magnetic head above the magnetic material surface can be adjusted based upon the calculated difference (Block 240). For example, with continuing reference to FIG. 1, the height of the magnetic head 110 above the magnetic material surface 108 can be adjusted to minimize and/or reduce the difference between the harmonic ratio and the reference harmonic ratio.

In some instances, the height of the magnetic head above the magnetic material surface can be adjusted when the calculated difference is greater than a threshold (Block 242). For example, with reference to FIG. 1, the DFH power DACs of disk drive assembly 102 can be adjusted based upon a calculated difference calculated between a harmonic ratio and a reference harmonic ratio for a track of magnetic material surface 108. Additionally, a touch down test can be initiated when the calculated difference is greater than a threshold (Block 250). With reference to FIG. 1, a newly determined harmonic ratio can be saved as a reference value in a RRO field associated with a servo wedge for the disk drive assembly 102. Then, process 200 can loop back to Block 220 and repeat one or more operations of Blocks 220, 230, 240, 242, and 250.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

1. A device comprising:
a disk drive assembly configured to store information using a platter comprising a magnetic material surface and a magnetic head disposed above the magnetic material surface, the magnetic head configured to move across a plurality of tracks formed on the platter to write information to the magnetic material surface and read information from the magnetic material surface; and
a controller operatively coupled with the disk drive assembly, the controller configured to dynamically adjust the height of the magnetic head above the magnetic material surface at each one of the plurality of tracks by determining a harmonic ratio for a particular one of the plurality of tracks and comparing the harmonic ratio to a reference harmonic ratio for the particular one of the plurality of tracks by calculating a difference between the harmonic ratio and the reference harmonic ratio, wherein the reference harmonic ratio is stored in a field associated with a servo wedge.

2. The device as recited in claim 1, wherein the disk drive assembly comprises a resistance heater positioned proximate to the magnetic head and configured to adjust the height of the magnetic head above the magnetic material surface using a digital-to-analog converter (DAC) coupled with the controller and connected to the resistance heater.

3. The device as recited in claim 1, wherein the reference harmonic ratio is determined during a manufacturing process.

4. The device as recited in claim 1, wherein the reference harmonic ratio is determined over a servo burst field for at least one of the plurality of tracks.

5. The device as recited in claim 1, wherein the reference harmonic ratio is stored in a repeatable runout (RRO) field associated with a servo wedge.

6. The device as recited in claim 1, wherein the controller is configured to adjust the height of the magnetic head above the magnetic material surface to reduce the difference between the harmonic ratio and the reference harmonic ratio when the difference between the harmonic ratio and the reference harmonic ratio is greater than a threshold.

7. The device as recited in claim 1, wherein the controller is configured to initiate a touch down test to determine a second reference harmonic ratio when the difference between the harmonic ratio and the reference harmonic ratio is greater than a threshold.

8. A method comprising:
determining a harmonic ratio for a particular one of a plurality of tracks formed on a platter comprising a magnetic material surface and a magnetic head disposed above the magnetic material surface, the magnetic head configured to move across the plurality of tracks to write information to the magnetic material surface and read information from the magnetic material surface;
calculating a difference between the harmonic ratio and a reference harmonic ratio for the particular one of the plurality of tracks; and
dynamically adjusting the height of the magnetic head above the magnetic material surface based upon the calculated difference between the harmonic ratio and the reference harmonic ratio, wherein the reference harmonic ratio is stored in a field associated with a servo wedge.

9. The method as recited in claim 8, wherein dynamically adjusting the height of the magnetic head above the magnetic material surface comprises using a resistance heater positioned proximate to the magnetic head and a digital-to-analog converter (DAC) connected to the resistance heater to adjust the height of the magnetic head above the magnetic material surface.

10. The method as recited in claim 8, wherein the reference harmonic ratio is determined during a manufacturing process.

11. The method as recited in claim 8, wherein the reference harmonic ratio is determined over a servo burst field for at least one of the plurality of tracks.

12. The method as recited in claim 8, wherein the reference harmonic ratio is stored in a repeatable runout (RRO) field associated with a servo wedge.

13. The method as recited in claim 8, further comprising adjusting the height of the magnetic head above the magnetic material surface to reduce the difference between the harmonic ratio and the reference harmonic ratio when the difference between the harmonic ratio and the reference harmonic ratio is greater than a threshold.

14. The method as recited in claim 8, further comprising initiating a touch down test to determine a second reference harmonic ratio when the difference between the harmonic ratio and the reference harmonic ratio is greater than a threshold.

15. A system comprising:
a control module; and
control programming configured to instruct the control module to dynamically adjust the height of a magnetic head above a magnetic material surface of a platter at each one of a plurality of tracks by determining a harmonic ratio for a particular one of the plurality of tracks and comparing the harmonic ratio to a reference harmonic ratio for the particular one of the plurality of tracks by calculating a difference between the harmonic ratio and the reference harmonic ratio, wherein the reference harmonic ratio is stored in a field associated with a servo wedge.

16. The system as recited in claim 15, wherein the reference harmonic ratio is determined during a manufacturing process.

17. The system as recited in claim 15, wherein the reference harmonic ratio is determined over a servo burst field for at least one of the plurality of tracks.

18. The system as recited in claim 15, wherein the reference harmonic ratio is stored in a repeatable runout (RRO) field associated with a servo wedge.

19. The system as recited in claim 15, wherein the controller is configured to adjust the height of the magnetic head above the magnetic material surface to reduce the difference between the harmonic ratio and the reference harmonic ratio when the difference between the harmonic ratio and the reference harmonic ratio is greater than a threshold.

20. The system as recited in claim 15, wherein the controller is configured to initiate a touch down test to determine a second reference harmonic ratio when the difference between the harmonic ratio and the reference harmonic ratio is greater than a threshold.
